(19) United States
(12) Patent Application Publication
(10) Pub. No.: US 2003/0180107 A1
(43) Pub. Date: Sep. 25, 2003

(54) Machining center

(76) Inventor: Heinrich Lutz, Dirlewang (DE)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/394,277

(22) Filed: Mar. 24, 2003

(30) Foreign Application Priority Data
Mar. 22, 2002 (DE) 102 13 056.6
Jan. 27, 2003 (DE) 103 02 985.0

(51) Int. Cl. B23B 3/00; B23B 39/22

(52) U.S. Cl. 408/39; 82/117

(57) ABSTRACT

A Machining center in particular for cutting machining of at least one workpiece is proposed wherein at least said one workpiece is held by a clamping device, which can drive along at least one direction, and wherein a machining unit, which can drive along at least one direction, carries at least three tool spindles wherein each drives one tool, and wherein the relative movement necessary for the positioning and for the machining or the relative movement necessary for the machining and the positioning of said tool and said workpiece is carried out through the movement of said clamping device as well as through the movement of said machining unit.

### BACKGROUND OF THE INVENTION

The invention relates to a machining center for in particular cutting machining of at least one workpiece.

Machining centers as mentioned before are known. In particular so-called multi-spindle machines are known where a plurality of spindles is positioned stationary and the workpiece is held on a clamping device and is positioned and can drive during the machining along the three space axes and, if necessary, also along several rotational axes at the tool spindles.

It is a disadvantage with these solutions according to the state of the art that the constructive expenses for the high degree of movement of the clamping device is enormous.

Furthermore machining centers are known which are characterised by a high flexibility which in particular comes from the fact that a plurality of machining tools can be replaced onto the tool spindles from a tool magazine. Naturally, the replacement procedure charges the machining time because in machining centers with a smaller number of spindles the replacement procedure blocks a cutting machining. Simultaneously the tool replacement contains the risk that a chip gets caught in the tool holding fixture and thus may lead to inaccurate measurements or machining errors.

The object of the present invention is to develop a machining center that, on the one hand, achieves a performance of cutting machining as high as possible and, on the other hand, has a construction as simple as possible.

### BRIEF DESCRIPTION OF THE INVENTION

The present invention provides a machining center in particular for cutting machining of at least one workpiece wherein at least said one workpiece is held by a clamping device, which can drive along at least one direction, and wherein a machining unit, which can drive along at least one direction, carries at least three tool spindles, each driving one tool, and wherein the relative movement necessary for a positioning or the machining or the relative movement necessary for the machining and the positioning of said tool and said workpiece is carried out through the movement of said clamping device as well as through the movement of said machining unit, either both of said movements are carried out simultaneously or only one of said movements is carried out at a time.

The invention suggests a subdivision of the movement necessary for positioning, respectively for machining, on the one hand into the movement of the clamping device, on the other hand into the movement of the machining unit. By means of this subdivision the high effort for a positioning of the clamping device in the space, as it is known in the state of the art, is avoided which eventually leads to smaller machining centers because the effort for the axes of movement which are nested one behind the other, as a rule orthogonal to each other, is omitted or clearly reduced. From that smaller masses result which have to be moved leading to smaller drives when the acceleration is constant.

By means of a number of spindle as high as possible, in particular three or more spindles in one machining unit, the invention achieves furthermore that already mounted tools which can be used, are available very close to the workpiece, which can be used immediately without a replacement of tools. Here the arrangement on one machining unit is an advantage because the respective drives for the different tool spindles can be collected sensibly through the common drive of the machining unit.

The invention has the advantage that very high performances of cutting machining can be achieved because no more time for a tool replacement is necessary, respectively the replacement of tools has not to be waited for during machining. Theoretically it could also be carried out parallel to the machining, for example by removing the machining unit not used from the workpiece and changing the workpiece in a certain distance to the cutting machining in order to avoid the risk of a caught chip in the tool holding fixture.

The distribution of the different axes of movement on the one hand to the clamping device and, on the other hand, to the machining unit, however, leads to a very simple mechanical construction which also leads to a simple drive and operation. If the construction is comparatively simple, a simple, convenient way of transport of the machine results.

The use of several spindles allows also an appropriate optimization of the spindles to the respective machining task, leading eventually to longer durability of the spindles because they are, on the one hand, only used shortly and will have over all a longer interruption time and, on the other hand, they can be adjusted each time to their application.

In a variant of the invention it is provided that the machining center has one or more machining units.

In a first step the user can use a machining center equipped only with one machining unit, if, for example, the machining which has to be carried out on the machining center, does not need, for the time being, a high number of tool spindles. However, it possible through the basically modular construction of the machining center according to the invention to integrate a second or additional machining units in a machining center which is firstly only equipped with one machining unit, the basic module already being provided with the technical arrangements for control. This allows an optimal adjustment of the machining center to present, but also to future machining tasks with little effort for changes, respectively set-up, for these new tasks.

It is convenient if the workpiece, respectively the workpieces, are machined at least simultaneously from two sides and at two points or if they are machined simultaneously at least from two sides or at two points. In order to achieve a high performance of cutting machining the invention proposes that as much spindles as possible of the machining center are being used. As far as it is possible because of the design of the workpiece possibly symmetric or parallel processes should be carried out, because a high performance of cutting machining is possible through parallel cutting machining. Here the invention allows a machining of the workpiece or the workpieces each from the same side (when the arrangement is accordingly) or a machining from two sides in opposition, the control providing accordingly that the machining steps do not collide or interfere with each other.

In particular the invention suggests that the movements distributed between the machining unit and the clamping device allow a relative positioning, respectively a movement, of the workpiece and the tool along the three space axes. The invention suggests furthermore that the different movements distributed between the machining unit and the clamping device allow a relative positioning, respectively a movement, of the workpiece or the tool along the three space axes. Eventually a relative movement of workpiece and tool is important on the one hand for positioning and on the other hand during machining. The invention suggests in particular that the movements are distributed between the machining unit and the clamping device, reducing the respective effort and, nevertheless, maintaining the same high flexibility. It is also possible to carry out also diagonal machining by means of a corresponding superposition of the single space axes of the different movements arranged preferably orthogonal to each other.

In a preferred embodiment of the invention it is provided that the machining unit or the whole machining center has a number of spindles which corresponds at least to the number of the tools which have to be used for the machining of the workpiece. Such an ample equipment of the machining unit, respectively the machining center, with a large number of spindles achieves that a change of tools during the machining is no longer necessary. Therefore between two machining steps only one new positioning of the respective desired tool on the workpiece has to be carried out, the otherwise known, difficult change of tools is omitted. From that results on the one hand a very high performance of cutting machining, because there is no time necessary for changing the tools, and on the other hand it is also secured that, with such a design of the machining center according to the invention, a high accuracy can be guaranteed because, by means of the omitted change of tools, there is no risk either of a caught chip in the tool holding fixture, which could lead to waste through inaccurate machining.

In a preferred embodiment of the invention it is provided that the machining unit is designed in such a way that it can move longitudinally and crosswise.

Depending on the number of workpieces as well as on the machining steps which have to be carried out it may be convenient according to the invention to design the machining unit movably only along one dimension. The workpiece is, for example, positioned in a first step with regard to a first machining unit wherein the machining unit then carries out a longitudinal movement (parallel to the rotational axis of the spindle) in order to carry out the machining step. Simultaneously it is provided in this case, for example, that a second machining unit is provided on the opposite side of the workpiece, the machining unit being positioned on a transverse table in such a way that it can move crosswise (parallel to the positioning direction of the clamping device), in order to bring the spindle into the right position, and then it carries out the machining step simultaneously by means of a longitudinal movement.

So in this example the first machining unit is designed movably only with respect to one axis, that is the longitudinal axis, and the second machining unit is designed movably for example in a horizontally orientated plane. The respective effort to realise an appropriate movement is low.

In another variant of the invention it is provided that the machining unit and the individual spindles can tip around an axis or a joint.

Such a design serves in particular for carrying out diagonal borings on the workpiece. However, it is also convenient to provide a small measurement of tipping of the spindle on the machining unit in order to, for example, realise the inclination during milling. It is also possible that the tipping of the spindle, respectively the machining unit, is carried out for example dynamically with the help of a corresponding actuating drive, or the machining unit, respectively the spindle, is tipped in a corresponding stationary angle. The orientation of the tipping axis is not limited here.

There is in particular the possibility that for carrying out machining steps along an axis inclined to the vertical and the horizontal the machining unit has one or more spindles which are orientated to this inclined axis and the superposition of the movement of the machining unit and the clamping device leads to a relative direction of the spindle movement which is parallel to the inclined axis. Another variant of the invention provides that for carrying out of machining steps along an axis, which is inclined vertically or horizontally, the machining unit has a spindle, which is parallel to the inclined axis, and the superposition of the movement of the machining unit and the clamping device leads to a relative direction of the spindle movement, which is parallel to the inclined axis. This makes it possible to achieve an arrangement through very low effort which allows the realisation of diagonal machining, for example boring of diagonal holes and so on. This is a result of the use of the superposition of the movement on the one hand of the clamping device and on the other hand of the machining unit which is carried out accordingly interpolating by means of the control. In particular the freely programmable, preferably computer-based, control allows a very large number of different machining procedures.

Preferably the spindle, the axis of which is inclined, is positioned on the machining unit (for example at the edge or the corner) that it does not interfere with other spindles or that the arrangement does not collide with other elements of the machining center. Furthermore the invention provides that the tipping of the single spindles can also be realised dynamically, an individual actuating drive being arranged for that. However, it is also possible to realise this tipping stationary on the machining unit.

According to the invention it is proposed that the machining unit carries the spindles in several rows arranged one above the other. The spindles are arranged in the row and, if necessary, in corresponding columns in such a way that during machining possibly all necessary spindles can be used and simultaneously no collision occurs with the clamping device or the other elements of the machining center.

As the clamping device often can be moved vertically it is possible, without any problems, to bring the respective concerned spindle to the respectively desired position of the workpiece for operation. In general it is naturally also possible to provide in addition to an horizontal also a vertical axis of movement on the machining unit, the invention is not limited at all in this respect.

It is provided to arrange 10, 15, 16, 20, 25 or even more spindles for one machining unit. Each of these spindles have to be driven, the effort for the drive increasing naturally for an according large number of spindles. Thus the invention proposes to provide one drive for several or all spindles of one machining unit.

Alternatively to that it is naturally also possible, as it is for example described in a variant according to the invention, to provide a single drive for each spindle. Thus it is possible to influence the drive of single spindles by means of the control and, for example, to stop them or to adjust them.

It is in particular convenient that the drive for a spindle group is arranged in this group and a driving belt, respectively a belt tensioning device, is provided for the drive of each part group of the spindles. By means of such an embodiment it is possible to provide a clearly smaller number of drives for driving a larger number of spindles, the respective effort for each spindle drive being reduced clearly. Often a driving belt is provided as drive, however, that could also be achieved through a gear or directly, a tensioning device for the belt being used when a belt is used in order to guarantee a safe drive of the spindles.

The clamping device carrying the workpiece or the workpieces is designed preferably in such a way that it can move horizontally and vertically or that it can either move horizontally or vertically. This serves for positioning the workpiece or the workpieces for the machining and moving them during machining or either for machining or moving them. Naturally the invention comprises also a variant where the clamping device allows more movement, in particular if the clamping device for the workpiece needs a machining which has to be rotated at least around a horizontal or vertical rotational axis. The invention is not limited here to the fact that either the clamping device or the machining unit or both of them are designed that each can move around three space axes. This may be really an advantage in special machining steps, the invention is not limited to it.

In particular a rotating embodiment of the clamping device allows a free positioning of the workpiece or several workpieces in the machining center.

In a further embodiment of the invention it is provided that the clamping device carries one or more, in particular two, respectively four workpieces, which are arranged preferably symmetric or point-symmetric. Depending on the size of the workpieces which have to be machined several workpieces may be clamped on the clamping device. However, this allows also simultaneously different machining principles. As already described above it is possible to design, in an arrangement of two machining units in the machining center, one machining unit only movable crosswise and the other machining unit movable crosswise and longitudinally. As far as only one (if necessary) large workpiece has to be machined it is convenient, if one machining unit is designed as special machining unit for this machining.

If it is possible to clamp on the clamping device several, if necessary, smaller workpieces, so it is, for example, possible to machine in two different clamping positions two times two, that is altogether four pieces, making a machining from four sides possible, if the clamping device is turned accordingly. It may also be an advantage that one of the two opposing machining units is designed fully flexibly in the plane.

In a variant of the invention it is also possible to arrange for example a third machining unit which is arranged parallel or rectangular to the two opposing machining units. This enhances further the variability of the invention.

It is an advantage if an interlinking device for the transport of the workpieces between the different machining centers is provided at the machining center and the clamping device takes over the workpiece or the workpieces from the interlinking device, respectively returns them after machining to the interlinking device.

Often several machining centers are arranged one behind the other in a machining line and connected through an appropriate interlinking device. For an operation as automatically as possible of such a machining line, respectively of the single machining center, it is convenient if the clamping device catches the workpiece conveyed by the interlinking device automatically and clamps it and transfers it to the machining and returns it again after machining into the interlinking device.

In particular it is an advantage if the clamping device is provided on a slide which can drive on a portal. Such an arrangement is in particular convenient with respect to the application of the invention in a machining line with interlinking device because the portal allows it easily that the clamping device takes over the workpiece from the interlinking device. The in-line arrangement of an additional, expensive loading robot, which otherwise takes the workpiece from the interlinking device and puts it into the clamping device, is not necessary here, the economical advantage is obvious.

Alternatively to the use of a portal on which the clamping device transports, if necessary, the workpiece suspended, it is possible that the clamping device is provided on a conveying bracket which can be driven. This second alternative, too, can be used according to the invention.

The design of the portal is chosen according to another variant of the invention in such a way that the portal rises above the machining unit and the connection to the interlinking device. In a further variant it is suggested that the portal rises above the machining unit or the connection to the interlinking device. This allows a high movability of the portal and a free positioning of the clamping device.

It is convenient if the work area enclosure of the machining center is connected to the portal, the necessary work area covers covering the complete machining center in a convenient, simple way.

### BRIEF DESCRIPTION OF THE DRAWINGS

FIGS. 1, 2 are, in a view, two variants of the machining center according to the invention.

FIG. 3 is a view of the machining center according to the invention with inclined machining unit.

FIG. 4 is a side view of the invention according to FIG. 2.

FIG. 5 is a schematic top view of the invention according to FIG. 2.

FIGS. 6, 7 are each a top view of two variants of the machining center according to the invention.

FIG. 8 is a view from the front of the machining unit of the machining center according to the invention.

### DETAILED DESCRIPTION OF THE PREFERRED EMBODIMENTS

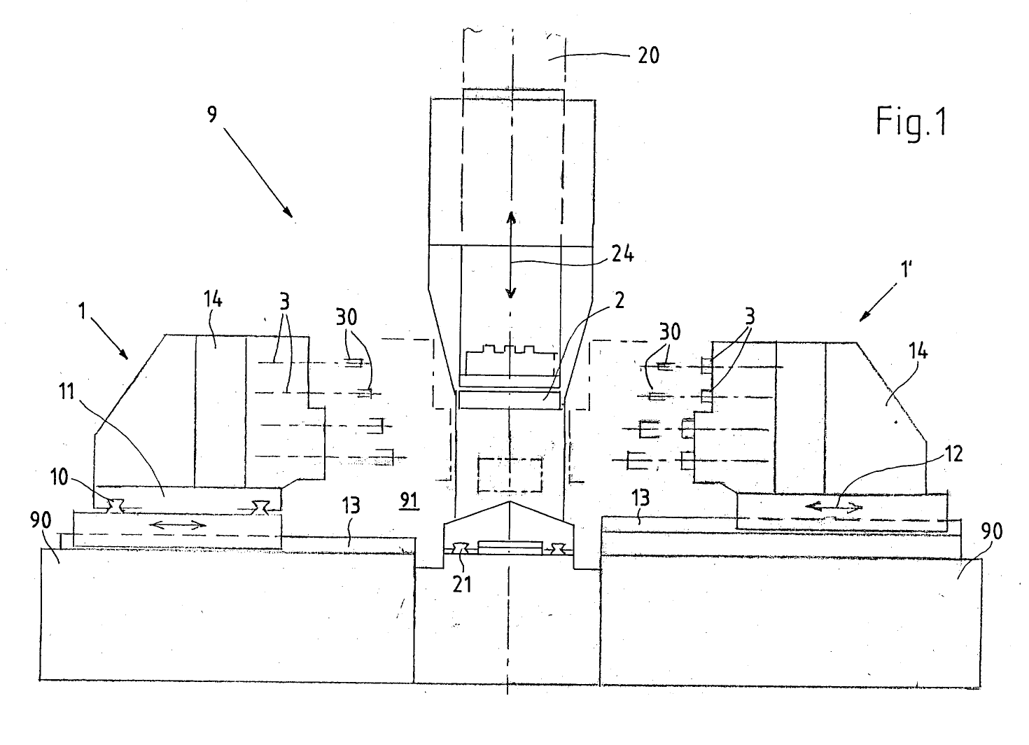

In FIG. 1 the first variant of the invention is shown schematically. The machining center is indicated generally by the reference number 9. The machining center 9 has a machine bed 90 through which the machining center is supported on the floor. In the embodiment shown here the machine bed 90 carries one of each machining units 1, 1′ which are arranged on the left hand and right hand side of the clamping device 2, and thus allow a machining of the workpiece 4, which is held by the clamping device 2, in opposition.

There are only schematic drawings which do not show all constructive details, however, make the essence of the invention clear.

The workpiece 4 is held by the clamping device 2, the clamping device 2 allowing a vertical positioning of the workpiece 4 along the double arrow 24. In the example shown here the clamping device 2 is held by a conveying bracket 20 on which the clamping device 2 can be displaced vertically (double arrow 24) and be shifted rectangular to the plane of the sheet. For that purpose the conveying bracket 20 is supported on the guide line 21, which is arranged between the two machining units 1, 1′.

According to the variant shown in FIG. 1 the clamping device 2 presents two axes of movement for the workpiece 4, that is a vertical axis 24 and an axis vertically to the plane of the sheet.

It is possible to twist the workpiece 4 around a vertical axis; this is not indicated in this figure.

The construction of the machining units 1, 1′ shown here is slightly different. Basically the machining units are supported each on a guide rail 13, which is arranged on the machine bed 90. Along this guide rail the machining unit can be moved longitudinally, and thus the spindle 3 of the machining unit can be screwed down against the workpiece 4. In order to improve the clearness the tool spindles 30 are often only indicated by their spindle axes.

In contrast to the machining unit 1′ on the right hand side the left hand machining unit 1 has, between the machining head 14, which carries the different tool spindles 3, and the guide rail 13 also a cross slide 11. This cross slide 11 is formed by a cross slide guide 10, on which the machining head 14 is supported, and which also can be moved rectangular to the plane of the sheet. Therefore the left hand machining unit 1 can be moved in a horizontal plane.

In contrast to that the right hand machining unit 1′ does not have such a cross slide 11. This machining unit can only move over the guide line 13 in one dimension along the double arrow 12.

Depending on the purpose of application of the machining center 9 it is provided to combine the arrangement of longitudinal movement 12 shown here, respectively the longitudinal and cross movement; this depends eventually on the shape and number of the workpieces 4 which have to be machined (there are several alternative variants).

The machining head 14 carries a plurality of tool spindles 3, which are indicated here only through the position of their respective axes for clearness purposes. Facing the workpiece 4 the tool 30, which is also only indicated here for clearness purposes, is mounted on the tool spindles 3. Here the tool spindles 3 are arranged in four rows one above the other, the workpiece being positioned for the time being over the vertical positioning 24 and the crosswise movement (rectangular to the plane of the sheet) of the clamping device 2 opposite the machining unit 1′ at the desired tool spindle 3. Naturally the arrangement of the tool spindles concerning size and distance of the rows has been chosen in such a way that they do not collide with respect to the concerned workpiece or carry out undesired machining procedures.

After the end of this positioning operation the left hand machining unit 1 is positioned with the help of the cross slide 11 parallel to the crosswise movement of the clamping device 2 so, that the desired spindle will carry out the desired machining. The respective level is already determined by the same position of the spindle and the same position of the second workpiece. However, if necessary, also an additional axis at the left hand machining unit may result in an additional variability.

The longitudinal movement in direction of the double arrow 12 of the two machining units 1, 1′ on the respective guide rails 13 serves for the machining.

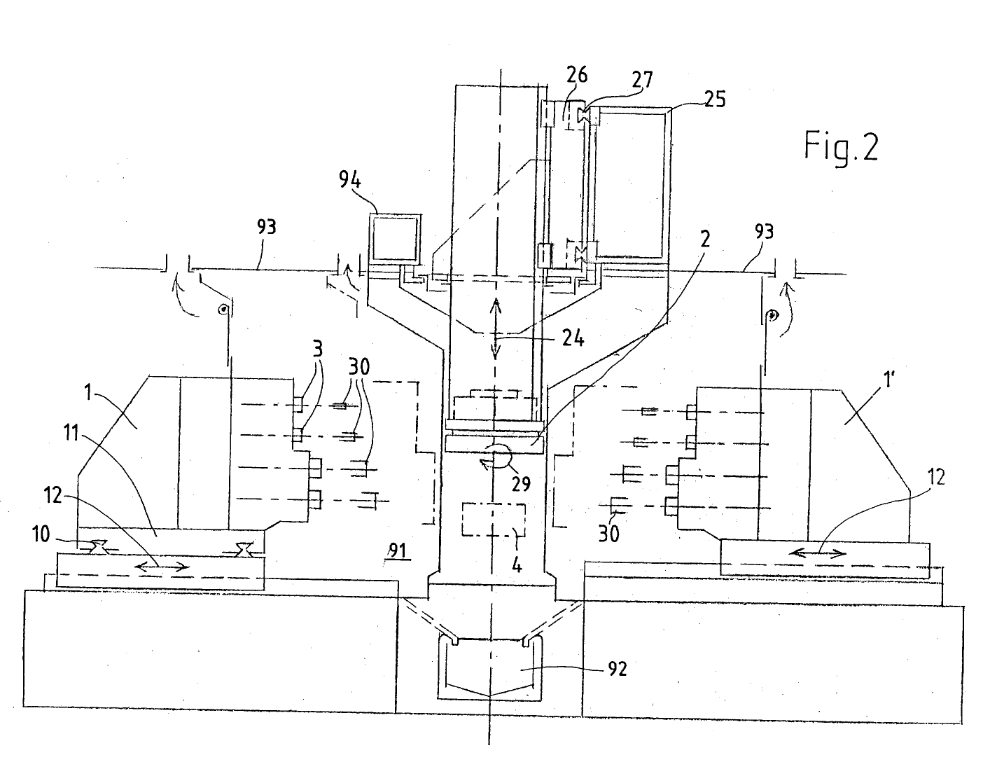

In FIG. 1 as well as in FIG. 2 the machining unit 1 is shown in the drawn-back position. The pushed-forward position of the machining unit 1, 1′ is shown with a dash-dotted line, resulting in the fact that the bottom tool spindles 3, respectively their tools 30, project more into the working room 91 of the machining center than the top ones. This avoids the risk of collisions of the top tool spindles 3 with the clamping device 2.

In contrast to the variant according to FIG. 1, in FIG. 2 the clamping device is arranged at the portal 25 in stead of a conveying bracket. The portal rises above the machining units and allows the slide 26 supported on it to drive in a direction rectangular to the plane of the sheet. For that purpose the portal 25 carries guide rails 27. The clamping device 2 can be again positioned vertically on the slide 26 (double arrow 24) and allows a twisting of the workpiece 4 around a vertical rotational axis along the rotational arrow 29. Compared with the clamping device on a conveying bracket 20 (according to FIG. 1) this embodiment according to FIG. 2 presents advantages.

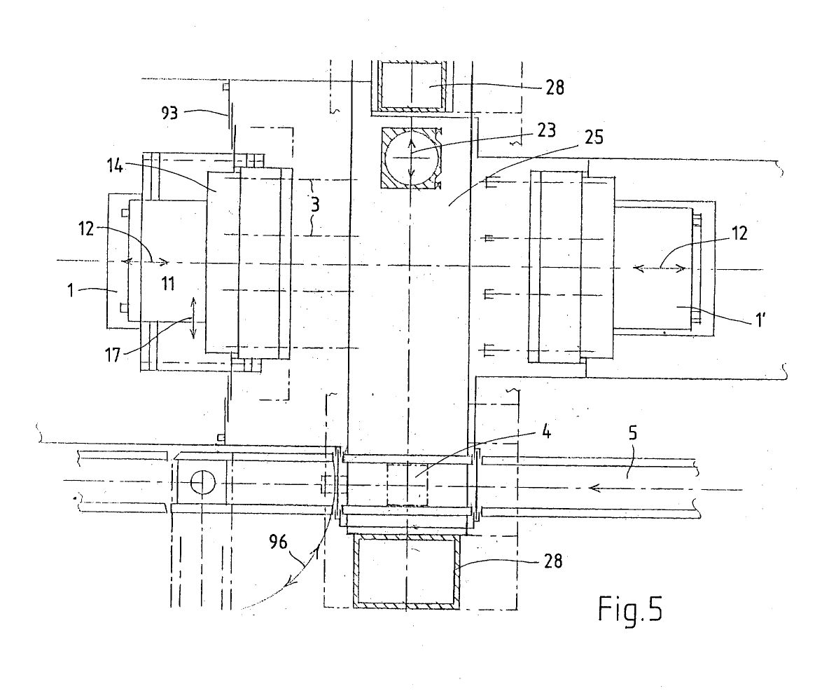

Firstly, it is possible that, if the workpiece 4 is mounted suspended on the clamping device 2, the space beneath the workpiece is free for taking away the chips. The conveying channel 92 for the chips is indicated. Furthermore, the suggestion of the clamping device 2 with a portal 25 allows in a simple way the integration of the machining center in an interlinking device 5 shown for example in FIG. 5. As the use of a separate loading and unloading robot between the interlinking device 5 and the clamping device 2 is not necessary, the clamping device guided at the portal 25 grasps the workpiece independently.

Furthermore, the use of the portal 25 allows also a comparatively easy construction of the covering 93 which encloses the machining center, the covering being partly connectable to the portal support 25 above the machining unit 1. If necessary additional covering supports 94 are provided parallel to the portal 25.

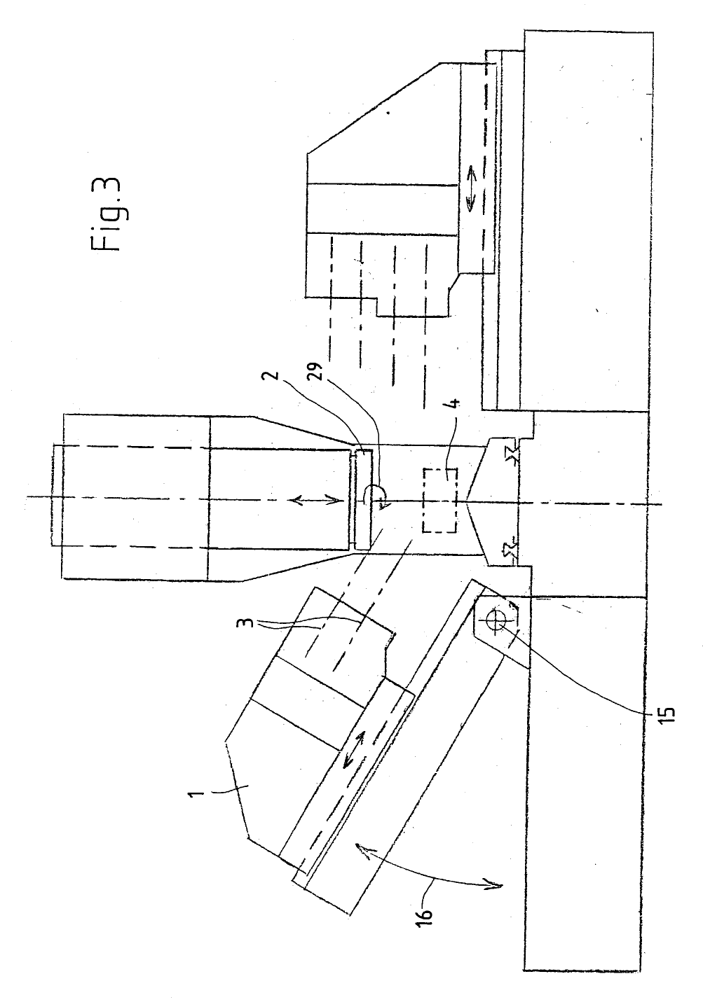

In FIG. 3 a variant of the machining center 9 according to the invention is shown wherein the left hand machining unit 1 can be tipped around a tipping joint 15 in such a way (tipping double arrow 16) that diagonal borings or milling machining and the like can be provided in the workpiece 4. The support, respectively the drive for the tipping, is not shown here for clearness reasons.

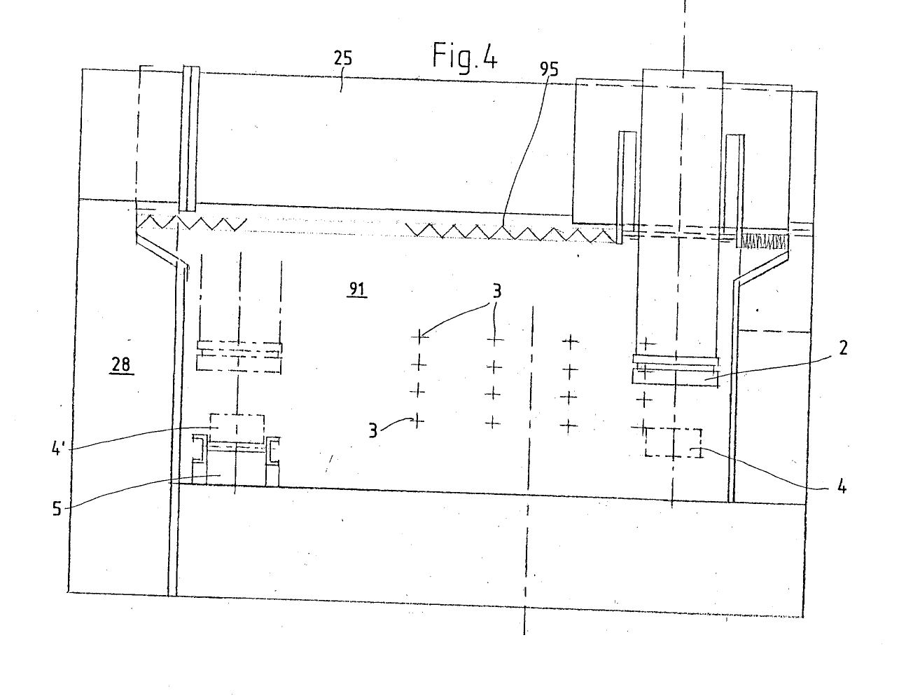

In FIG. 4 a side view of the invention is shown which is carried out in a portal construction 25. A folding bellow-like covering 95, which encloses the working room 91 upwards, is connected to the slide 26 on both sides. In the right hand part of the working room 91 altogether 16 tool spindles 3 in four rows and in four columns are indicated schematically by a cross for their axes. The tool 4 can be positioned on each of these tool spindles 3. To the outer left the interlinking device 5 is shown and, dash-dotted, the clamping device 2 in this position. Also dash-dotted a workpiece 4′, which has just been conveyed to or away, is supported on the interlinking device 5 in order to convey the workpiece 4′ to another machining. It is the advantage of the portal construction 25 that the clamping device 2 does not only serve for clamping the workpiece 4 during its machining, but also simultaneously the workpiece 4′ can be removed from the interlinking device 5 or be put onto it.

In FIG. 5 a top view according to FIG. 2 is shown. The portal 25 is held by the supports 28, the portal rising not only above the length of the machining units 1, but also above the interlinking device 5.

The interlinking device 5 is designed as a conveying belt or the like, and is separated by corresponding passing doors from the working room 91, making it possible to obtain automatic feeding and removing of the workpieces 4, 4′. The clamping device 2 can move, as it is shown here by means of the double arrow 23, in longitudinal direction on the portal 25. This longitudinal movement is rectangular to the conveying direction of the interlinking device 5.

The movement of the cross slide 11, which is parallel to it, is indicated by the double arrow 17. Movable covering elements 93 enclose the working room 91 in the area of the machining units 1.

As the right hand machining unit 1 can only move in one dimension, the construction for the covering 93 is simpler there. In order to make the working room 91 accessible, sliding doors are provided, because the interlinking device 5 covers one of these doors, the interlinking can be swung away in the area of the door. The swinging area of the interlinking 5 is indicated with the double arrow 96. Alternatively also swinging doors can be used.

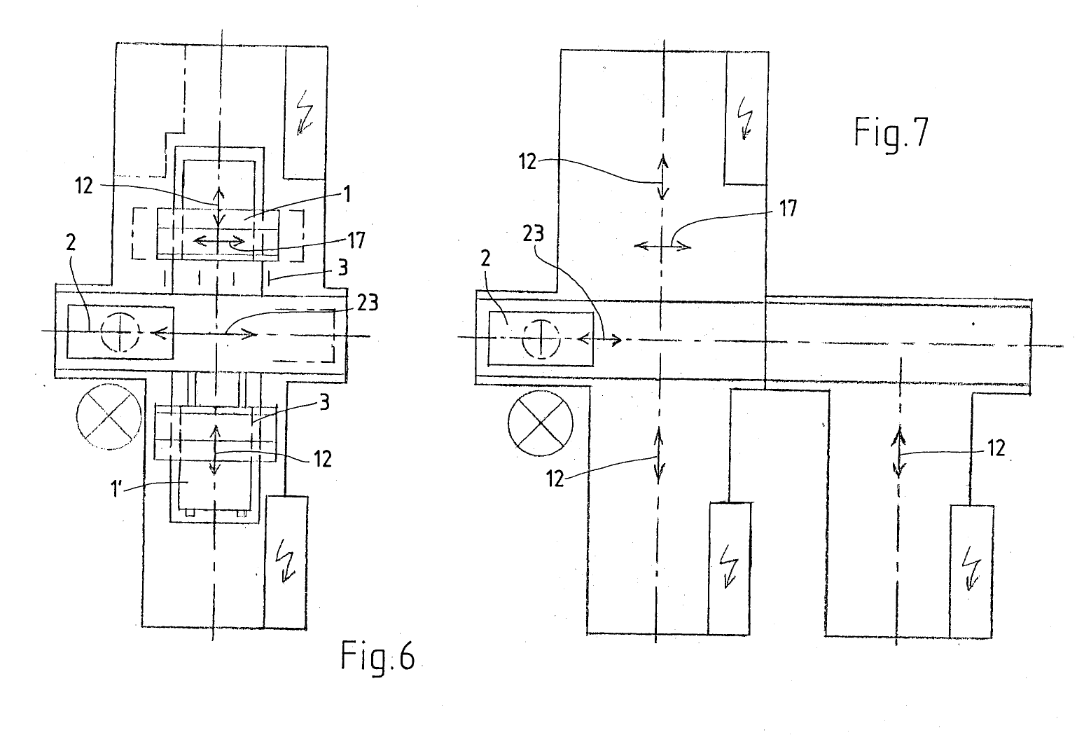

FIG. 6 shows, similar to FIG. 7, different rough possibilities of arrangement of the machining center. In the variant of FIG. 6 only two machining units 1 and 1′ are arranged in opposition to each other. The basically module-like construction of the machining center according to the invention, however, allows to begin firstly with only one machining unit, then add the opposed second machining unit, and then, in a later state of the development for example, three machining units, as indicated in FIG. 7, are arranged. From that it is possible to adjust the machining center according to the invention to the respective machining tasks optimally.

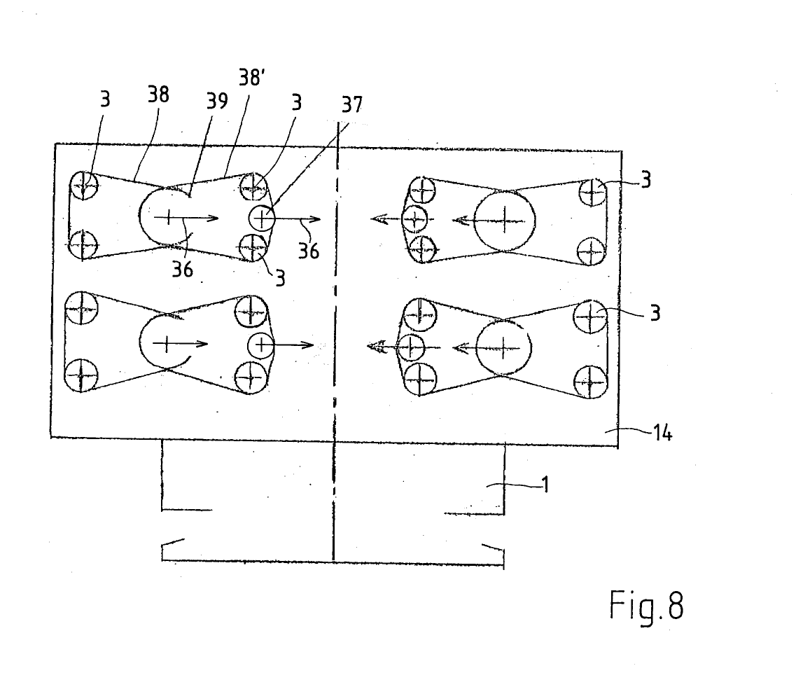

As described, 16 drive spindles 3 are proposed for example for a machining unit 1. The use of 16 drives for them is comparatively expensive, so that in FIG. 8 a drive concept is suggested for which, if necessary, also independently protection is required, that is independent from the special embodiment of the machining center. Here a group of tool spindles, for example four tool spindles, are driven by a drive 39. Two V-belts 38, 38′, which drive each two tool spindles 3, engage at the drive 39, for example an electromotor. Altogether four tool spindles 3 are driven by one drive 39. Because of the elongation of the belt belt tightening devices are provided, this being for example a tightening roller 37 or the arrangement of the driving motor 39 on a movable, but fixable tightening slab. Each direction of tightening is shown by the arrow 36.

Although the invention has been described in terms of specific embodiments which are set forth in considerable detail, it should be understood that this is by way of illustration only and that the invention is not necessarily limited thereto, since alternative embodiments and operating techniques will become apparent to those skilled in that art in view of the disclosure.

Accordingly, modifications are contemplated which can be made without departing from the spirit of the described invention.

1. Machining center in particular for cutting machining of at least one workpiece wherein at least said one workpiece is held by a clamping device, which can drive along at least one direction, and wherein a machining unit, which can drive along at least one direction, carries at least three tool spindles wherein each drives one tool, and wherein the relative movement necessary for the positioning or for the machining or the relative movement necessary for the machining and the positioning of said tool and said workpiece is carried out through the movement of said clamping device as well as through the movement of said machining unit, either both of said movements are carried out simultaneously or only one of said movements is carried out at a time.

2. Machining center according to claim 1 wherein said machining center has one or more of said machining units.

3. Machining center according to claim 1 wherein said workpiece or said workpieces are machined simultaneously at least from at least two sides and at two points.

4. Machining center according to claim 1 wherein said workpiece or said workpieces are machined simultaneously at least from two sides or at two points.

5. Machining center according to claim 1 wherein said workpiece is arranged between two of said machining units.

6. Machining center according to claim 1 wherein said different movements distributed between said machining unit and said clamping device allow a relative positioning, respectively movement, of said workpiece and said tool along the three space axes.

7. Machining center according to claim 1 wherein said different movements distributed between said machining unit and said clamping device allow a relative positioning, respectively a movement, of said workpiece or said tool along the three space axes.

8. Machining center according to claim 1 wherein said machining unit carries a plurality of said spindles which corresponds at least with the number of said tools which have to be used for the machining of said workpiece, respectively said workpieces.

9. Machining center according to claim 1 wherein said machining unit is designed in such a way that it can move longitudinally and crosswise.

10. Machining center according to claim 1 wherein said machining unit and said spindle can tip around an axis or a joint.

11. Machining center according to claim 1 wherein said machining unit or said spindle can tip around an axis or a joint.

12. Machining center according to claim 1 wherein for carrying out of machining steps along an axis, which is inclined vertically and horizontally, said machining unit has a spindle, which is parallel to said inclined axis, and the superposition of said movement of said machining unit and said clamping device leads to a relative direction of the spindle movement, which is parallel to said inclined axis.

13. Machining center according to claim 1 wherein for carrying out of machining steps along an axis, which is inclined vertically or horizontally, said machining unit has a spindle, which is parallel to said inclined axis, and the superposition of said movement of said machining unit and said clamping device leads to a relative direction of the spindle movement, which is parallel to said inclined axis.

14. Machining center according to claim 1 wherein said machining unit carries said spindles in several rows one arranged above the other.

15. Machining center according to claim 1 wherein said spindles are arranged on said machining unit in such a way that they do not collide with said clamping device or other elements of said machining center.

16. Machining center according to claim 1 wherein said tools of the bottom spindles project further into the working space of said machining center than said tools of the top spindles.

17. Machining center according to claim 1 wherein a single drive is provided for each of said spindles.

18. Machining center according to claim 1 wherein one drive is provided for several or all of said spindles of one of said machining units.

19. Machining center according to claim 1 wherein said drive for one group of said spindles is arranged within this group and that for each of said drives of a part group of said spindles one driving belt is provided, if necessary with a belt tightening device.

20. Machining center according to claim 1 wherein said belt tightening device is formed by a tightening roller which acts on said driving belt and which can be moved and fixed.

21. Machining center according to claim 1 wherein said belt tightening device is formed by a clamping plate which carries said drive and which can move and be fixed.

22. Machining center according to claim 1 wherein said clamping device for said workpiece can rotate around at least a horizontal and vertical rotational axis.

23. Machining center according to claim 1 wherein said clamping device for said workpiece can rotate around at least a horizontal or vertical rotational axis.

24. Machining center according to claim 1 wherein said clamping device is designed in such a way that it can move horizontally and vertically in order to position, respectively move, said workpieces accordingly.

25. Machining center according to claim 1 wherein said clamping device is designed in such a way that it can move horizontally or vertically in order to position, respectively move, said workpieces accordingly.

26. Machining center according to claim 1 wherein said clamping device carries one or more, in particular two, respectively four, of said workpieces which are arranged preferably symmetric or point-symmetric to a rotational axis of said clamping device.

27. Machining center according to claim 1 wherein an interlinking device for the transport of said workpieces between said different machining centers is provided at said machining center and said clamping device takes over said workpiece, respectively said workpieces, from said interlinking device, respectively transfers them to said interlinking device after machining.

28. Machining center according to claim 1 wherein said clamping device is provided on a slide which can drive on a portal.

29. Machining center according to claim 1 wherein said portal rises above said machining unit and the connection to said interlinking device.

30. Machining center according to claim 1 wherein said portal rises above said machining unit or the connection to said interlinking device.

31. Machining center according to claim 1 wherein a work area enclosure of said machining center is connected to said portal.

32. Machining center according to claim 1 wherein said clamping device is provided on a conveying frame which can be driven.

33. Method for machining one or more of said workpieces in a machining center according to claim 1 where at first said workpiece is positioned relatively to a first tool spindle of a first machining unit and after that or simultaneously a second tool spindle is positioned over a second machining unit on said workpiece.
